(19) United States
(12) Patent Application Publication
(10) Pub. No.: US 2006/0080266 A1
(43) Pub. Date: Apr. 13, 2006

(54) Mailer detection and manifest system

(76) Inventors: Shahrom Kiani, Arlington, TX (US); Cheryl C. Miller, Ellicott City, MD (US); Eddie Kin Hang Lui, Euless, TX (US); Sekhavat Sharghi, Arlington, TX (US); Michael J. Cykana, Mansfield, TX (US)

Correspondence Address: Philip G. Meyers;Philip G. Meyers Law Office, Suite 300, 1009 Long Prairie Road, Flower Mound, TX, 75022, US

(21) Appl. No.: 11/171,536

(22) Filed: Jun. 30, 2005

Related U.S. Application Data
(60) Provisional application No. 60/617,186, filed on Oct. 8, 2004.

(51) Int. Cl. G06F 17/00; B65B 35/00; G07B 17/02

(52) U.S. Cl. 705/402; 705/406; 705/408

(57) ABSTRACT

The invention provides a system and method for the automatic detection of items as originating from a specific source, e.g. client or customer, identifying specific characteristics of the items, comparing these characteristics to a database of sets of such characteristics identified with or more sources, and providing an output of items that match the characteristics. In one embodiment of the invention, a mailer detection and manifest system detects mail pieces that were sent by specific mailers using mail piece characteristics that are unique to the mail pieces of each mailers' job within a mixed mailer mail stream. This is preferably accomplished in real-time or near real-time while sorting the mail pieces after the mailers' specific mail piece characteristics have been determined.

This application claims priority of U.S. Provisional Ser. No. 60/617,186, filed Oct. 8, 2004.

### TECHNICAL FIELD

This invention relates to sorting systems and methods used in mail processing facilities, especially presort mailers.

### BACKGROUND OF THE INVENTION

Pre-sort mailers typically perform automated processing of mail pieces for delivery to a customer. These mailers receive mail in batches from customers which they combine and sort in order to obtain postal discounts. Letter shops create mail and combine mail created for different customers using sorting machines in a manner similar to presort mailers. Both will be referred to as “pre-sorters” in the discussion below. Sorting machines used by pre-sorters are similar to those used at the USPS, namely DBCS and MLOCR machines. These businesses provide a service to their customers by processing items according to standard USPS rules for automated mail handling. This processing in turn reduces the postage rate charged to the customer.

Current state of the art practice requires that one mailers' mail pieces be kept segregated from other mailers' mail pieces. Individual processing is then necessary to ensure that their material is sorted according to ZIP codes, discounts applied according to USPS standards for pre-sorted mail, and then manifested for shipment to the USPS. The manifest accounting for the entire sort for each of the mailers then has to be generated manually.

A single customer (mailer) of the presort mailer or letter shop may have multiple jobs and wants an accounting for each job, each of which is assigned a “customer number”, which is effectively a job number. This type of report is difficult to generate under present practice. Currently, in order to run a series of jobs, the operator of the sorting machine must shut down the sorting machine temporarily and change the customer number manually, causing delay and occasional operator errors which in turn cause errors in customer billing. Labeled divider cards marking the end of one job and the beginning of another have been tried to address these problems, but with limited success.

Once mail from multiple jobs has been combined in the sorting process, the pre-sorter loses track of how many mail pieces for each mailer have been included in a given mailing that will receive a bulk mail discount. The mailer thus does not know how much the actual postage on its mailings was, and the difference may represent extra profit to the pre-sorter. The present invention provides an improved system for keeping track of presort mailing information that addresses these difficulties.

### SUMMARY OF THE INVENTION

The invention provides a system and method for the automatic detection of items as originating from a specific source, e.g. client or customer, identifying specific characteristics of the items, comparing these characteristics to a database of sets of such characteristics identified with or more sources, and providing an output of a list of items that match the characteristics. In one embodiment of the invention, a mailer detection and manifest system detects mail pieces that were sent by specific mailers using mail piece characteristics that are unique to the mail pieces of each mailers' job within a mixed mailer mail stream. This is preferably accomplished in real-time or near real-time while sorting the mail pieces after the mailers' specific mail piece characteristics have been determined. In one aspect, the present invention detects mail pieces from specific mailers in a mixed mailer mail stream, keeps track of the individual mailers' mail that goes to a specific ZIP code, and then sorts the mail piece according to the ZIP Code. Manifests are generated according to both mailer and ZIP code.

The invention permits single pass sorting of material from multiple mailers in a mixed mailer mail stream with manifests automatically generated both for individual mailers and the entire pre-sort operation. This process helps eliminate operator error, which is a major cause of concern to both the pre-sorter and the USPS. The added accuracy of the statistics gathered by automation will enable the USPS to allow the pre-sorter to commingle mail for multiple CAPS (Centralized Accounts Processing System) accounts, thus improving the sorting make-up and associated discounts. Another advantage of the invention is to dramatically increase the utilization of the sorting equipment by eliminating the frequent start/stop of the sorter to manually change the mailer identification. Bar code only sorting systems would be enhanced with OCR capabilities, allowing identification of UAA (Undeliverable As Addressed) mail pieces. UAA-identified pieces can be accounted for by mailer, and optionally sorted to a special sort pocket. This provides a tremendous advantage for standard/direct mail in reducing postage for pieces that would eventually not be delivered by the USPS, as they would otherwise become dead letter mail. These and other aspects of the invention are described further in the detailed description that follows.

### BRIEF DESCRIPTION OF THE DRAWING

In the accompanying drawing:

FIG. 1 is a front view of a typical mail piece processed using the method of the invention; and

FIG. 2 is a flow chart of a process for sorting presort mail according to the invention.

### DETAILED DESCRIPTION

A mail sorting system of the invention uses a sorting machine which is a transport with multiple sorting pockets. The transport includes cameras capable of surveying the entire mail piece or other item capable of being conveyed down the transport. The transport in the case of mail pieces is preferably a pinch belt conveyor wherein the mail pieces are held on opposite sides by a pair of belts as they are transported. However, other types of known mail sorting machines could be used. The pinch belt leads past a series of diverter gates at which the mail piece can be diverted to a bin to one side of the conveyor path. Typical DBCS and MLOCR machines operate in the manner.

Prior to use of the system, an operator has put in a database all information pertinent to any job (the “input profile”) that may be run on the equipment. This information can include, but is not limited to: mailer identity, postage applied (if known), endorsements, indicia, symbols and other patterns. Location of the information on the mail piece is also indicated. Each input is marked as “critical” or “non-critical” by the system or the operator according to a pre-determined standard. This designation will subsequently be used to accept the mail piece if information is correct and complete, or reject it if its information cannot be verified. As an alternative to operator input, a few sample mail pieces may be scanned, and the scanned mail piece information extracted and stored in the database with the customer ID assigned to the information and used for reference. The database may also contain sort schemes that an equipment operator can preselect prior to starting processing.

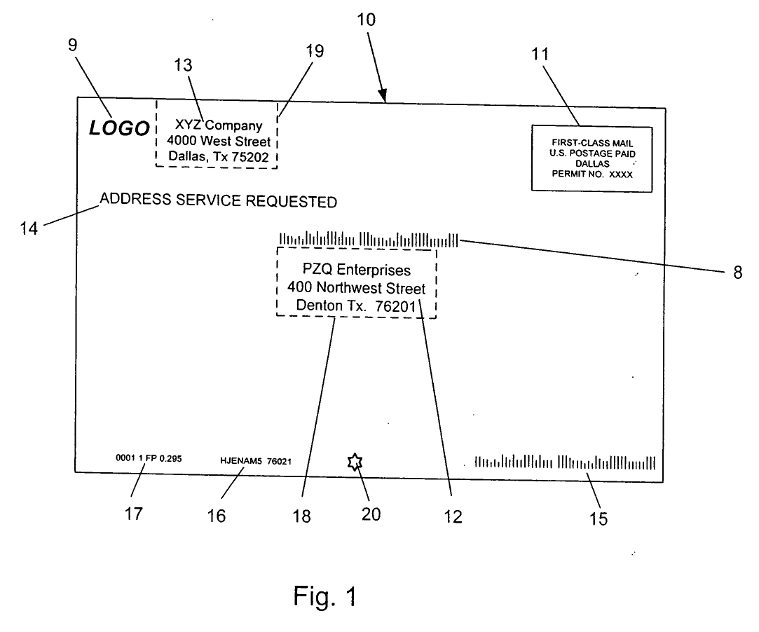

Mail identifiers may be created as follows. A sample mail piece is first imaged, and the captured image is used to extract mail piece features. FIG. 1 illustrates a typical mail piece 10 with features such as permit imprint 11, address 12, return address 13, endorsement 14, Postnet bar code 15, automarking 16, manifest keyline information 17 and Planet bar code 8, which contains an assigned ID number associated with the mailer. Keyline information 17 is a series of text/digits that uniquely identify a mailer and job, along with mail piece characteristics such as mail weight. Such mailings also commonly have advertisement text and special patterns/graphics characteristic of each mailer. While the address 12 will vary on each mail piece, other items will remain the same for all mail within the same job, for example, the return address 13. Logo 9 and any other distinct graphic objects can be located anywhere on the mail pieces other than at locations reserved for essential features as described above.

The input file can be created manually by a video operator, who reviews the mail piece image on screen and identifies regions of interest such as 18, containing the address, and 19 containing the return address. The decoded text in ROI 19 may be designated a critical parameter in that all mail pieces from the job associated with that profile are expected to have that return address. The permit number will likewise be considered a critical parameter. What is considered critical by the system analyzing a mail piece image will vary depending on the program logic the system employs to make the decision. The input process may be based on a few mail pieces that are representative of all the mail pieces in a job. The reverse side of the mail piece may contain information of interest and is preferably characterized in the same manner as the front side. The goal of the input process is to create a “profile” of features by which a specific mailers' mail pieces can be recognized as they pass through the sorting system, preferably without need for either a special symbol identifying the mailer or use of markers such as divider cards to indicate a change in mailer during a sorting run.

Region of interest (ROI) features extraction and matching software has been developed and tested in real time to find and characterize features of the mail piece from the mail piece image. Delivery address blocks, return address blocks, stamps and permit blocks, meter mark, logo, etc. were found and characterized. The return address block, delivery address blocks and the permit blocks, etc. were submitted for OCR processing. The geometrical information of each object and the results of this OCR processing were used to match the current mail piece to a predetermined template.

The result of template matching can be used to determine the customer ID for the mail pieces being processed. If some fields match but not all, operator intervention may be required. It may occur that multiple jobs are received from the same mailer at the same time where the mail pieces are identical in appearance and layout, and it is possible or desirable to commingle them in order to obtain a higher overall postal discount. In such a case, the mail piece may include a special symbol or number 20 put on by the mailer that distinguishes mail from one job for that mailer from another. A different symbol or number 20 is used for each successive job for that mailer.

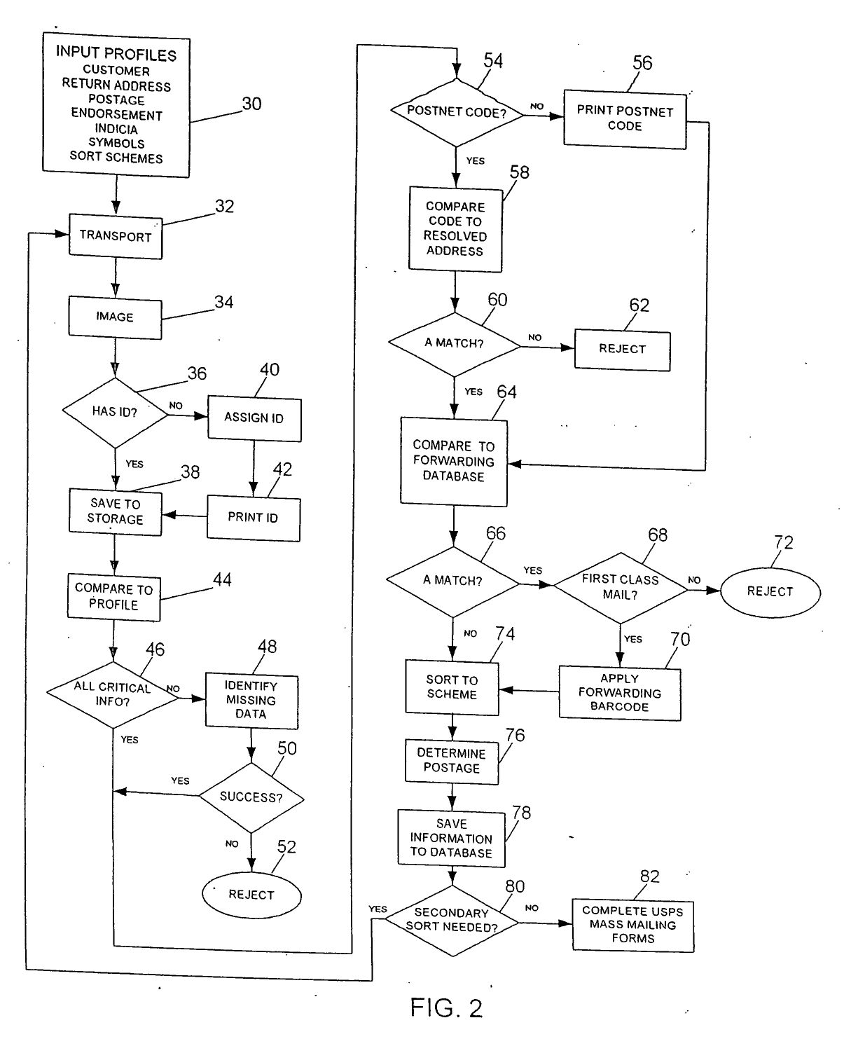

Referring to FIG. 2, once the input of mailer profile data is completed (step 30), the machine operator places mail pieces on the transport (step 32), such as by loading them onto a conventional pickoff feeder, without any requirement to input information such as mailer ID, etc. Mail pieces can be randomly selected or of mixed origin, since each will be uniquely identified by the input parameters or by a mail piece unique ID. The transport carries each mail piece past a digital camera to lift an image (step 34). If this image has a unique ID (decision 36), the information is stored, such as on hard disk storage (step 38) where it may be retrieved later. If no unique ID is determined, the system assigns one (step 40), applies the ID to the mail piece (step 42), and the information is stored in the disk storage. The ID number assigned may be either unique to each mail piece, or just unique to that mailer, with all mail pieces for that mailer receiving the same ID number. The same ID number could have both attributes, e.g., the first six digits or characters identify the mailer, and the remaining digits or characters uniquely identify the mail piece. An “ID number” for this purpose refers to any combination of numbers, letters, or other symbols sufficient for identification purposes.

All data from the image lift is resolved and compared with the input profile (step 44), and confirmation is made assuring that all data marked critical is available (decision 46) so that the mailer can be reliably determined. Any missing critical data undergoes an algorithm matching process (step 48) to determine if the system can identify missing data. If successful (decision 50), the mail piece is approved for further processing. If not, the mail piece is sorted to a special reject bin for offline processing (step 52). If the mailer can be determined, then counters are incremented for number of mail pieces to that ZIP code, number of mail pieces sent by that mailer, number of mail pieces sent by that mailer in that ZIP code and any other desired information, such as the number of mail pieces of that mailer in the current job. This information is stored in memory and/or saved to disk for preparation of manifests or other reports.

If a Postnet bar code exists (decision 54), the system compares the applied bar code to the resolved address (step 58) and determines whether a match exists (decision 60). If there is not a match, the mail piece is rejected for offline processing (step 62). The resolved address is also compared with a national forwarding database (step 64) to determine if forwarding is required (decision 66). One such forwarding database having improved capabilities as compared to the NCOA database is described in Sipe et al. U.S. Patent Application 20040093222, published May 13, 2004, the contents of which are incorporated by reference herein. If forwarding is needed and the machine has forwarding capability, then if the mail piece is first class mail (decision 68), it will apply the forwarding bar code (step 70), and reject other types of mail for offline processing (step 72). Machines without forwarding capability will all reject pieces requiring forwarding.

If no Postnet bar code exists and the machine is equipped to print a Postnet code determined from the resolved address, the Postnet code is printed (step 56) and then the check for forwarding is carried out. If the machine does not have the capability of applying a determined bar code, the mail piece is instead rejected. Alternatively, the piece could be sorted to its destination using the delivery point assigned by the OCR process.

Once all the above is accomplished, the mail piece Postnet bar code is matched against a predetermined sort scheme, and a proper sort is effected (step 74). The sort scheme may assign the mail piece to a final sort (“quick kill”), or send it into a location where a secondary sort is required. Upon determination of the proper sort, correct postage is determined (step 76) and sent to the database holding all other pertinent information on the mail piece, including the postage applied if there is pre-applied postage (meter, stamps, etc.) (step 78).

If the mail piece requires a secondary sort (decision 80), the process is accomplished in the same manner as an initial sort by again feeding the mail piece to the transport that has an operator-preset sort scheme. The mail piece is identified by its profile or unique number in step 36, and again proper sorting is accomplished. Proper postage may now have changed, and the information is corrected in the database in steps 76, 78. All other parameters should not have changed. After all sorting, primary and secondary, is completed, data in the database, including an image of the mail piece, is now available for completing all required USPS forms (step 82) for mass mailings. All information is retained, including postage applied, postage owed, value added rebates, number of mail pieces, number assigned to each sort level and each destination. By accessing the unique ID for any given mail piece, an exact profile of the information can be obtained. This data is available for verification purposes and archived for subsequent retrieval should audit at later date be required.

The algorithm matching process of step 48 can be done by deduction based on other data. For example, the return address is unreadable from the image lift for some reason, but upon considering other factors such as permit number, endorsements and their location, and the like, the program logic narrows the possibilities down to only one matching mailer and job. For a similar process relating to missing address information, see commonly-owned U.S. Provisional Application Ser. No. 60/530,879, filed Dec. 18, 2003, the contents of which are incorporated by reference herein. The system can be programmed with limited error tolerance if desired. For example, if a mis-scan of one or two letters in the return address occurs, a computer may return a mismatch initially but then override the mismatch based on the high correspondence of all the other letters in the address.

The database created in the foregoing example contains an exact profile of each mailing by mailer. Information such as number of pieces, rejects, incorrect addresses, postage required vs. postage applied, distribution by zip code and other information can be easily extracted and verified as well as information on each mail piece. With this information, automatic invoices can be prepared. This also allows a presorter to reward mailers with error free mail and penalize with additional fees those whose mailing lists contain errors.

In a variation according to the invention, secondary processing can be used in an attempt to selectively sort rejects by mailer. When a mail piece is rejected in steps 52 or 62 due to an inadequate address or because the Postnet code does not match the resolved address, the system will normally know the associated mailer from the profiling procedure, and can direct the mail piece to a mailer-specific reject bin that receives all rejects for that mailer. If the system does not know the mailer, it can then attempt to determine which mailer the unsortable mail piece belongs to. This can be done in a number of ways, such as by means of the special mailer job ID symbol 20, Planet bar code 8, and possibly logo 9, by matching an assigned mail piece ID number with the associated mailer, or by using process of elimination program logic in conjunction with known elements of address and other information resulting from the imaging step to determine the mailer.

In the case of a complete misread where no information is available about a mail piece, the system can sort the rejected mail piece based on information concerning the immediately preceding and/or following mail pieces. If the system detects a series of mail pieces belonging to a single mailer on this basis, it can assign the mail piece to the reject bin associated with that mailer. The number of mail pieces following the rejected one that will be considered as part of a possible series is limited to those which can be imaged and processed before the rejected mail piece has traveled from the imaging camera to the gates for the reject bins. It may be advantageous to assign the bins requiring the longest travel from the imaging system as reject bins to permit more time for processing and increase the number of following mail pieces that can be considered as part of a series.

Predetermined criteria based on the desired confidence level are used to determine if the rejected mail piece is part of a series belonging to a particular mailer. For example, if the system detects that three mail pieces immediately following and preceding the reject all belong to the same mailer, it then assigns the reject to the reject bin for that mailer. The image of the rejected mail piece may then be reviewed in an offline processing operation similar to manual video coding used by the USPS.

In an alternative embodiment of the invention, the steps 36, 40 and 42 wherein an ID number is determined and printed on each mail piece are omitted. This version of the invention is appropriate where, due to machine configuration, there is insufficient time between imaging and sorting to perform advanced processing. In such a case, processing of the mail piece image in step 34 proceeds along two parallel tracks. The first track only includes operations needed to make the sorting decision in a manner known in the art. The second track, which may be performed by a secondary processor, uses the information from the image to determine which mailer the mail piece belongs to, and performs any other computations that do no need to be completed before making the sorting decision, e.g., the number of mail pieces assigned to each zip code which is maintained in order to do the final postage calculation. In this manner, secondary processing can lag behind the primary sorting processing without adversely affecting operation.

As discussed above in connection with reject processing, the system may also rely on series information in making decisions, recognizing that in a great many cases a long series of almost identical mail pieces will be imaged. Thus, if the image information does not provide enough critical data to identify the mailer, the system may look to the mail pieces preceding and/or following that mail piece. If a series of mail pieces immediately before and after the mail piece that can't be resolved all belong to the same mailer, the probability is high that the unresolved mail piece also belongs to that mailer, and may be identified accordingly. Storage of the image on a permanent storage medium such as a hard drive in step 38 makes it possible to investigate and determine what went wrong with the mail piece later on, with a change in the assigned job number if the system's determination proves to be incorrect. Series information can also be used for process control purposes. If more than a predetermined number of unreadable pieces pass by the imaging camera, the sorting system is preferably programmed to shut down so that the operator can investigate for a potential machine problem.

In the case of multiple jobs received from the same mailer at the same time where the mail pieces are identical in appearance and layout, there are several possible approaches. First, the human operator can manually interrupt a run in this situation and enter a new job code, overriding the existing one, much as currently practiced for all jobs. Second, if the system is provided with the data, e.g. tables linking zip codes to the corresponding job number for that mailer, then the system can automatically determine the correct job code from the recipient address. Third, by pre-arrangement, the mailer can used the special symbol (indicia) or mark 20 as noted to distinguish one job from another, and the verification of the mark is added to the list of critical features.

According to a further aspect of the invention, it is not essential to reject all mail pieces for which a mailer cannot be determined. Where there are a large number of mail pieces in a batch that do not match a mailer profile, it is likely that they all originate from a single mailer that for some reason was not profiled, or for which the profile was not recognizable by the system. In such a situation, the system can assign a pseudo-mailer ID to the unidentified mail pieces and sort them according to zip code, rather than to a reject bin. The mailer for these mail pieces can then be determined later in an offline process using the saved data for each mail piece, including the images of the mail piece.

It will be understood that the foregoing description is of preferred exemplary embodiments of the invention, and that the invention is not limited to the specific forms shown. Items other than mail pieces such as flat and large pieces could be identified by the process of the invention. Modifications may be made in without departing from the scope of the invention as expressed in the appended claims.

1. A process for the automated detection of an item in a stream of items from different sources as originating from a specific source, comprising:
identifying specific item characteristics that uniquely identify the source of an item;
detecting these characteristics as the stream of items passes through a material handling system;
comparing the detected characteristics to records of a database containing sets of characteristics identified with each source to determine if a match can be made; and
recording the number of items in the stream that originated from the specific source.

2. A process for the identification of a mail piece in a stream of mail pieces being sorted in a sorting machine as belonging to a specific mailer, wherein the stream of mail pieces is a mixed mail stream containing mail originating from two or more mailers, comprising:
identifying sets of mail piece characteristics that identify mail pieces originated by each mailer;
detecting these characteristics for each mail piece as the stream of mail pieces passes through the sorting machine;
comparing the detected characteristics to a database containing the sets of characteristics identified with mailers to determine if the detected characteristics match one set of the characteristics, thereby identifying the mail piece with its mailer; and
recording the number of mail pieces in the stream that belong to that mailer.

3. The process of claim 2, further comprising computing postage for each mailer based on total number of mail pieces in a sorted batch, volume discounts based on the total number of mail pieces in the batch, and the number of mail pieces recorded as belonging to that mailer.

4. The process of claim 2, further comprising saving to a permanent data storage medium data concerning each mail piece, including its associated mailer.

5. The process of claim 4, wherein the saved data includes an image of at least one face of each mail piece.

6. The process of claim 2, wherein the comparing step further comprises using a computer-implemented deductive process to determine which mailer sent the mail piece.

7. The process of claim 6, wherein the computer-implemented deductive process includes: determining the mailer of a series of mail pieces immediately preceding and/or following the mail piece; and if the mail pieces in the series all originated from the same mailer, concluding that the mail piece was sent by the same mailer as the mail pieces in the series.

8. The process of claim 2, wherein when a mail piece must be rejected due to an incorrect address, sorting that mail piece to a reject bin associated with the mailer of the mail piece.

9. The process of claim 2, further comprising assigning a pseudo mailer ID to mail pieces for which no mailer ID can be identified, and assigning the pseudo mailer ID to a mailer in an offline process after sorting is completed.

10. The process of claim 2, wherein the specific item characteristics comprise features selected from one or more of a permit imprint, return address, endorsement, manifest keyline information, Planet bar code and logo graphics.
